(19) United States
(12) Patent Application Publication
(10) Pub. No.: US 2019/0201722 A1
(43) Pub. Date: Jul. 4, 2019

(54) EMERGENCY MOBILE DEVICE CASE WINDOW-BREAKING TOOL

(71) Applicant: Mark Petrie, Queensbury, NY (US)

(72) Inventor: Mark Petrie, Queensbury, NY (US)

(21) Appl. No.: 16/239,235

(22) Filed: Jan. 3, 2019

Related U.S. Application Data
(60) Provisional application No. 62/613,490, filed on Jan. 4, 2018.

(51) Int. Cl. A62B 3/00; B26F 1/32; F16M 13/00; B60R 22/32; H04M 1/21

(52) U.S. Cl. CPC A62B 3/00; B26F 1/32; B60R 2022/328; B60R 22/32; H04M 1/21; F16M 13/00

(57) ABSTRACT

Approaches presented herein are directed at a mobile device case including an emergency tool (e.g., a window-breaker, a seatbelt cutter). The mobile device case comprises a first compartment formed by an interior face of a mobile device enclosure for holding a mobile device (e.g., a smart phone, a tablet). The emergency tool is housed within a second compartment that is attached to an exterior face of the mobile device enclosure.

### CROSS-REFERENCE TO RELATED APPLICATIONS

This application claims the benefit of U.S. Patent Application No. 62/613,490, filed on Jan. 4, 2018, the contents of which are hereby incorporated by reference in its entirety.

### TECHNICAL FIELD

The present invention relates generally to devices for use in emergency situations and, more specifically, devices for breaking a window in an emergency situation.

### BACKGROUND

In an emergency, an emergency safety device, such as an emergency hammer, may be used to break a glass window of a vehicle or building in order to provide an exit for people trapped inside the vehicle or building when doors are stuck closed or otherwise inaccessible. An emergency hammer, for example, generally has a plastic handle and a steel tip. This steel tip enables the safety hammer to break through tempered glass and create an opening. Tempered glass, when hit with blunter objects, may merely crack without breaking apart, thereby failing to create an exit. In some instances, an emergency hammer may also have a cutting tool on the end of the hammer opposite of the steel tip. This cutting tool can be used to slice through seatbelts in the event that a person is trapped by a vehicle seatbelt.

### SUMMARY

Approaches presented herein are directed at a mobile device case. The mobile device case comprises a mobile device enclosure, an emergency tool, and a second compartment. The mobile device enclosure includes an interior face and an exterior face, wherein a first compartment is defined by the interior face and configured to hold a mobile device. The emergency tool is attached to the exterior face. The second compartment is configured for housing the emergency tool, wherein the second compartment is selectively attached to the exterior face of the mobile device enclosure.

The mobile device case may include additional aspects. For example, the mobile device case may further comprise a spring that is compressed in the second compartment behind the emergency tool. In another example, the mobile device case may further comprise a holster-attaching mechanism that comprises the second compartment. Also, the second compartment may comprises a cylindrical structure that runs along at least a portion of a side wall of the exterior face of the mobile device enclosure. The mobile device case may also comprise a mobile device support stand comprising the second compartment, wherein the emergency tool emerges from the second compartment in the case that a sufficient quantity of force acts upon an end of the mobile device support stand. In another example, the second compartment may be a cylindrical structure that extends outwards from the exterior face of said mobile device enclosure, wherein the second compartment is configured to be removable from the mobile device enclosure to expose the emergency tool, or the emergency tool may emerge from the second compartment in the case that a sufficient quantity of force acts upon an end of the mobile device support stand.

Additional objects, advantages and novel aspects of the present invention will be set forth in part in the description which follows, and will in part become apparent to those in the practice of the invention, when considered with the attached figures.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1A and FIG. 1B show a top view and a front view, respectively, of an emergency tool concealed in a safety sheath at a top of a mobile device enclosure according to one illustrative embodiment of the invention;

FIG. 2A and FIG. 2B show a top view and a back view, respectively, of an emergency tool concealed in a pop-out mobile device support on a back of a mobile device enclosure according to another illustrative embodiment of the invention;

FIG. 3A and FIG. 3B show a top view and a back view, respectively, of an emergency tool concealed in a belt-holster-attaching mechanism on a back of a mobile device enclosure according to yet another illustrative embodiment of the invention; and

FIG. 4A and FIG. 4B show a top view and a front view, respectively, of an emergency tool concealed in a safety sheath on a side of a mobile device enclosure according to still another illustrative embodiment of the invention.

The drawings are not necessarily to scale. The drawings are merely representations, not intended to portray specific parameters of the invention. The drawings are intended to depict only typical embodiments of the invention, and therefore should not be considered as limiting in scope. In the drawings, like numbering represents like elements.

### DETAILED DESCRIPTION

Consider driving down a windy road by a lake in upstate New York one day and seeing a car plummet over an embankment and into the water. You can see a mother and baby trapped in the car, the mother pounding her fists against the window to no avail. You next try to determine how to help them. You know you bought a little tool to break a window in case that ever happened to you, but, to your dismay, you didn't know where the tool is and, in this emergency, the seconds are ticking away for you to find it in time. It's not in your glove box; you are not even sure it's in your car. You try throwing a rock into the window, but it bounces off, and the car slips the rest of the way under the water. By the time EMTs have arrived, it is too late.

Afterwards, as you absentmindedly check your cell phone for missed calls, you wonder what you could have done differently. If only you had known where the window breaking tool was, maybe things would have happened differently.

No one would want to find themselves in the above situation. Although people often buy tools (e.g., seatbelt cutters, window breakers) to help themselves or others in emergency situations, these tools can quickly be misplaced and forgotten about in the weeks following their purchase. By the time an emergency arises, such emergency tools are therefore inaccessible and of no help. However, the inventor of the present invention has found a solution to this problem. These days, the one item that everyone always knows the location of and is kept in easy reach at all times is a cell phone or other mobile device. Accordingly, the inventor of the present invention has devised several solutions for integrating an emergency window-breaking tool into a mobile device case for quick and reliable access in an emergency situation.

Illustrative embodiments will now be described more fully herein with reference to the accompanying drawings, in which illustrative embodiments are shown. It will be appreciated that this disclosure may be embodied in many different forms and should not be construed as limited to the illustrative embodiments set forth herein. Rather, these embodiments are provided so that this disclosure will be thorough and complete and will fully convey the scope of this disclosure to those skilled in the art.

Furthermore, the terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. Furthermore, similar elements in different figures may be assigned similar element numbers. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

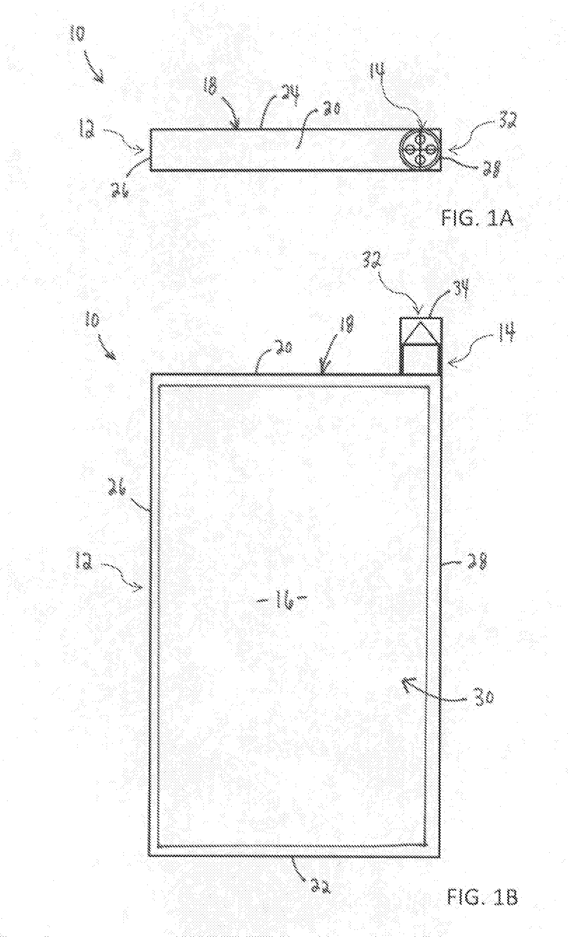

Referring now to the drawings in detail, and initially to FIGS. 1A and 1B, reference numeral 10 generally designates a mobile device case that may be used in accordance with one aspect of the present invention. Mobile device case 10 may include a mobile device enclosure 12 and an emergency tool 14. Mobile device case 12 includes an interior face 16 and an exterior face 18. Exterior face 18 includes a top wall 20, a bottom wall 22, a back wall 24, and opposing side walls 26, 28. A first compartment 30 is formed by interior face 16 and is configured to hold a mobile device (not shown), such as, but not limited to a mobile phone.

Emergency tool 14 may be attached to or extend from exterior face 18 of mobile device enclosure 12. For example, emergency tool 14 may extend from top wall 20 of mobile device enclosure 12. In one embodiment, emergency tool 12 may be housed within a second compartment defined by a safety sheath 32 to prevent emergency tool 14 from inadvertently causing injury when not in use. In this embodiment, safety sheath 32, for example an antenna-like member or cap-like member, may be selectively attached to top wall 20 of mobile device enclosure 12 and extend upwards therefrom. In some embodiments, safety sheath 32 can have the appearance of an antenna or be otherwise camouflaged to appear as a conventional part of mobile device enclosure 12 or a mobile device covered by mobile device enclosure 12. In some embodiments, safety sheath 32 can be configured to break off, twist off, or otherwise be removable from mobile device enclosure 12 in order to reveal emergency tool 14. Alternatively, safety sheath 32 can be configured to slide or collapse into mobile device enclosure 12 when force (e.g., from pushing safety sheath 32 against a window of an automobile) is brought against an upper portion 34 of safety sheath 32. In still further embodiments, mobile device case 10 does not include safety sheath 32 and, instead, emergency tool 14 is exposed on the top of mobile device case 10.

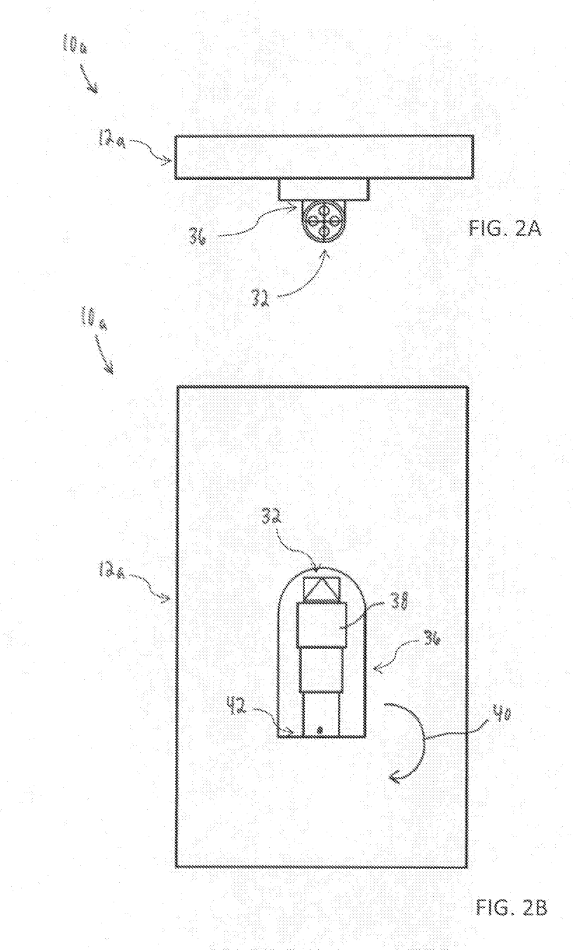

Referring now to FIG. 2A and FIG. 2B, a top view and a back view, respectively, of another version of mobile device case 10a is provided. In particular, emergency tool 36 is concealed in safety sheath 32 that is within or part of a pop-out or flip down mobile device support 38. The mobile device support 38 is disposed on back wall 24 of a mobile device enclosure 12a that is configured to house a mobile device, such as a mobile phone, according to an embodiment of the present invention are shown. In this embodiment, emergency tool 36 can form a bottom portion of a pop-out or flip down mobile device support 38. In some embodiments, pop-out or flip down mobile device support 38 can be rotated 40 one-hundred eighty degrees relative to mobile device enclosure 12a about an axis 42 and moved away from mobile device enclosure 12a in order to form a supportive leg holding mobile device enclosure 12a (and a mobile device held in mobile device enclosure 12a) in a slanted, upright position. In some embodiments, emergency tool 36 can be concealed in the bottom structure of pop-out or flip down mobile device support 38. Mobile device support 38 can be configured to reveal emergency tool 36 when force (e.g., from pushing mobile device support 38 against a window of an automobile) is brought against the end/bottom structure of mobile device support 38. In still further embodiments, emergency tool 36 can be exposed on the end of mobile device support 38 and provide a point of contact between mobile device support 38 and a surface on which mobile device case 10a is supported (e.g., a table).

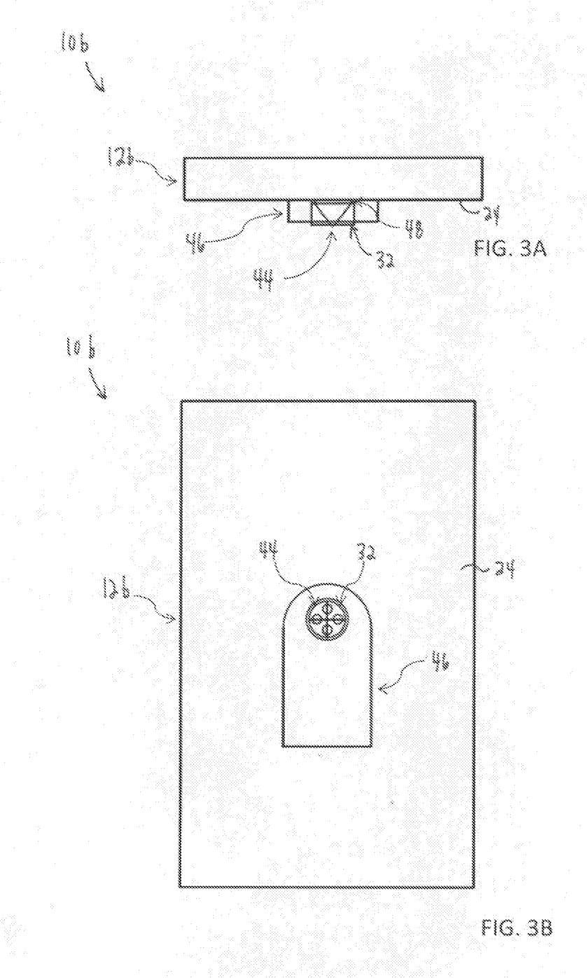

Referring now to FIG. 3A and FIG. 3B, a top view and a back view, respectively, of an emergency tool 44 concealed in safety sheath 32 that is within or part of a second compartment, such as, for example, a belt-holster-attaching mechanism 46, on back wall 24 of mobile device case enclosure 12b configured to house a mobile device, such as a mobile phone, according to an embodiment of the present invention are shown. In this embodiment, emergency tool 44 can be spring loaded with a spring 48. Spring 48 may be disposed between emergency tool 44 and belt-holster-attaching mechanism 46, or between emergency tool 44 and back wall 24, for example. Spring 48 can be released by a trigger (not shown), such as pressing a button or clicking down on emergency tool 44. Releasing spring 48 transforms the potential energy stored in spring 48 into kinetic energy that drives emergency tool 44 away from back wall 24 of mobile device enclosure 12b and against a window, thereby breaking the window. In some alternative embodiments, spring-loaded emergency tool 44 can be located and built into mobile device enclosure 12b anywhere on mobile device enclosure 12b, not just in belt-holster-attaching mechanism 46 on back wall 24 of mobile device enclosure 12b.

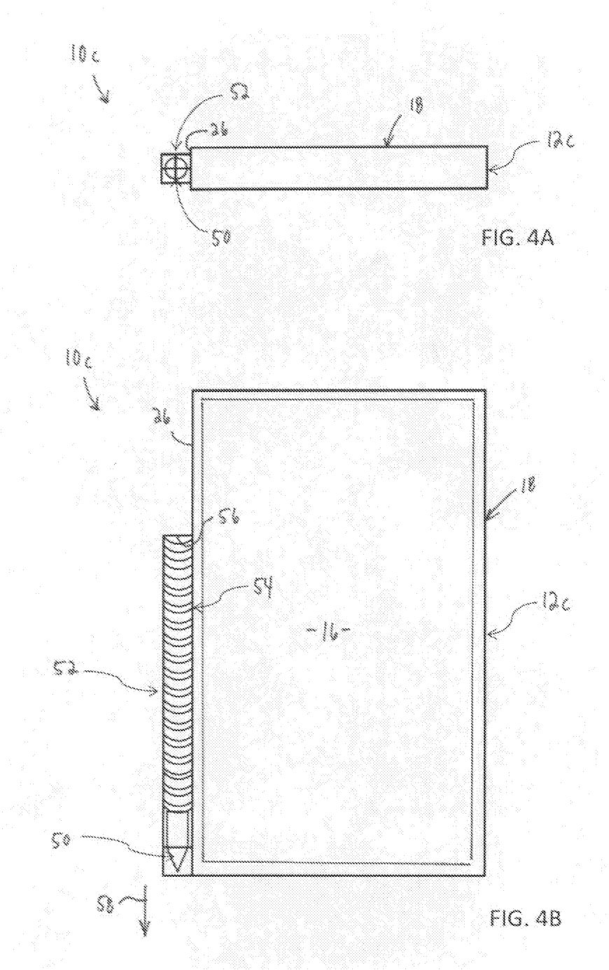

Referring now to FIG. 4A and FIG. 4B, a top view and a front view, respectively, of an emergency tool 50 concealed in a second compartment, such as a safety sheath 52 (e.g., cylindrical structure) on a side wall 26 of a mobile device enclosure 12c configured to house a mobile device, such as a mobile phone, according to an embodiment of the present invention are shown. In this embodiment, emergency tool 50 can be spring loaded with a spring 54. Spring 54 may be disposed between an end wall 56 of safety sheath 52. Spring 54 can be released by a trigger (not shown), such as pressing a spring release button, to release the potential energy stored in spring 54 as kinetic energy driving emergency tool 50 in a direction 58 downward against a window. In some embodiments, emergency tool 50 is actuated into a break position upon the press of a trigger. The trigger is configured to release a hammer (not shown) that is engaged by spring 54, wherein spring 54 is biased to move the hammer onto emergency tool 50.

It should be understood that in in some embodiments of the present invention, emergency tool 14 (FIGS. 1A-B), 36 (FIGS. 2A-B), 44 (FIGS. 3A-B), or 50 (FIGS. 4A-B) can be a lightweight, metal (e.g., steel) spike or pin for breaking a window of an automobile. In some other embodiments of the present invention, the emergency tool can be a spike or pin made of an alternative material having sufficient strength to break a window of an automobile when hit against that window. In some further embodiments, the emergency tool can be an emergency tool having a functionality other than breaking a window. For instance, in some embodiments, the emergency tool can be a seatbelt cutter.

Furthermore, it should be understood that mobile device enclosures come in may dimensions and can have specific features (e.g., a storage pocket), openings (e.g., for a camera), and components (e.g., a screen protector) based on a type of mobile device (e.g., smart phone, tablet) as well as make and model of the mobile device to be held in the mobile device enclosure. Accordingly, the Figures depict mobile device enclosures 12 (FIGS. 1A-B), 12a (FIGS. 2A-B), 12b (FIGS. 3A-B), and 12c (FIGS. 4A-B) as simple rectangles with no features, openings, or components. This depiction is not intended to be limiting and it should be understood that many mobile device enclosure variations are possible within the scope of embodiments of the present invention.

While the invention has been particularly shown and described in conjunction with exemplary embodiments, it will be appreciated that variations and modifications will occur to those skilled in the art. Therefore, it is to be understood that the appended claims are intended to cover all such modifications and changes that fall within the true spirit of the invention.

What is claimed is:

1. A mobile device case comprising:
a mobile device enclosure comprising an interior face and an exterior face, wherein a first compartment is defined by said interior face and configured to hold a mobile device;
an emergency tool attached to said exterior face; and
a second compartment configured for housing said emergency tool, wherein said second compartment is selectively attached to said exterior face of said mobile device enclosure.

2. The mobile device case of claim 1, wherein said emergency tool is a spike configured to break a window.

3. The mobile device case of claim 2, wherein said spike comprises metal.

4. The mobile device case of claim 2, further comprising a spring, wherein said spring is compressed in said second compartment behind said spike.

5. The mobile device case of claim 4, further comprising a holster-attaching mechanism, wherein said holster-attaching mechanism comprises said second compartment.

6. The mobile device case of claim 4, wherein said second compartment comprises a cylindrical structure running along at least a portion of a side wall of said exterior face of said mobile device enclosure.

7. The mobile device case of claim 1, further comprising a mobile device support stand comprising said second compartment.

8. The mobile device case of claim 7, wherein said emergency tool emerges from said second compartment in the case that a sufficient quantity of force acts upon an end of said mobile device support stand.

9. The mobile device case of claim 1, said second compartment being a cylindrical structure extending outwards from said exterior face of said mobile device enclosure.

10. The mobile device case of claim 9, wherein said second compartment is configured to be removable from said mobile device enclosure to expose said emergency tool.

11. The mobile device case of claim 9, wherein said emergency tool emerges from said second compartment in the case that a sufficient quantity of force acts upon an end of said mobile device support stand.

12. The mobile device case of claim 1, wherein said emergency tool is a blade configured to cut a seatbelt.

13. The mobile device case of claim 1, wherein said second compartment is a closed compartment configured to conceal the emergency tool.

14. The mobile device case of claim 1, wherein said second compartment comprises at least on open side from which said emergency tool is configured to extend.

15. The mobile device case of claim 1, wherein said mobile device enclosure is configured to hold a smart phone device.

16. The mobile device case of claim 1, wherein said mobile device enclosure is configured to hold a tablet device.
